(19) United States
(12) Patent Application Publication
(10) Pub. No.: US 2025/0384655 A1
(43) Pub. Date: Dec. 18, 2025

(54) Method for Automatically Categorizing Data Items

(71) Applicant: Varonis Systems, Inc., New York, NY (US)

(72) Inventors: Ron Sneh, Atlit (IL); John Eugene Neystadt, Kfar Saba (IL); Amit Osi, Tel Aviv-Yafo (IL); David Bass, Karmei Yosef (IL); Amir Belgi, Ra'anana (IL)

(21) Appl. No.: 18/747,202

(22) Filed: Jun. 18, 2024

(51) Int. Cl. G06V 10/70; G06F 16/906; G06F 21/62

(52) U.S. Cl. CPC G06V 10/70; G06F 16/906; G06F 21/62; G06F 2221/2141

(57) ABSTRACT

Broadly speaking, the present techniques provide an automatic way of classifying data items within an environment (e.g. a business, workplace, organisation, etc.). This is advantageous over existing techniques which require manual classification of data items, which is time consuming in environments where hundreds of new data items may be generated in a day or week. The present techniques use an embedding machine learning, ML, model and an LLM to automatically determine the relevant classification label(s) for an unlabelled data item.

### FIELD

The present application generally relates to a method for automatically classifying data items within an environment.

### BACKGROUND

Many organisations have policies which control actions that can be performed using or with respect to data items within the organisations. For example, organisations may have a policy to retain all emails sent and received by a person within the organisation for five years, after which they can be deleted. Similarly, organisations may have a policy that prevents certain data items from being transmitted outside of the organisation, or which controls who can access the data items within the organisation, or which controls how long data items should be retained before they can be deleted/purged. With huge volumes of digital data items being generated within organisations on a yearly and even daily basis, it is desirable to automate the application of such policies to the data items. However, this may require understanding the data items in some way, so that the appropriate policy/policies can be applied. For example, it may be useful to classify the data items. Currently, classification rules that help to determine how data items are classified may be manually generated, which is difficult and time consuming.

The present applicant has therefore recognised the need for an improved way to automatically categorise or classify data items within an organisation or environment.

### SUMMARY

In a first approach of the present techniques, there is provided a computer-implemented method for autonomously classifying uncategorised data items within an environment, the method comprising: obtaining, from at least one data source within the environment, a plurality of uncategorised data items; generating, using a machine learning, ML, model, at least one embedding vector for each uncategorised data item, where the at least one embedding vector represents content of each uncategorised data item; clustering, using the at least one embedding vector generated for each uncategorised data item, the plurality of uncategorised data items into a plurality of clusters, where each cluster contains a subset of the plurality of uncategorised data items that are more similar to each other than to the uncategorised data items in other clusters; generating, using a large language model, LLM, at least one classification label specific to content of the subset of the plurality of uncategorised data items in the cluster; and applying, to each uncategorised data item in each cluster, the at least one classification label generated for the cluster, thereby generating a labelled data item.

Advantageously, the present techniques provide a way to automatically classify an unlabelled data item within an environment (e.g. a business, workplace, organisation, department within an organisation, etc.). This is advantageous over existing techniques that require manual classification of data items, which is time consuming in environments where hundreds of new data items may be generated in a day or week. As noted above, the present techniques make use of a machine learning model and a large language model to automatically determine the relevant classification label(s) for an unlabelled data item.

In some cases, the automatic classification may be used to automatically retrieve at least one data management policy to be applied to data items. The data management policy may be any security and/or data retention policy. For example, the data management policy may be a policy that prevents certain data items from being transmitted outside of the organisation, or that controls who can access the data items within the organisation, or that controls how long data items should be retained before they can be deleted/purged, or moved from primary storage to secondary or tertiary storage. The data management policy may be used to implement national or regional regulation or law, such as the European Union's General Data Protection Regulation (GDPR), or the USA's Data Privacy Protection laws.

The present techniques are also advantageous over existing techniques that automatically classify unlabelled data items using rules and regular expression matching, because relevant rules and regular expressions are difficult to create for specific environments and can suffer from false positives. The present techniques do not classify unlabelled data items by applying rigid classification rules or by pattern/expression matching. Instead the present techniques use embeddings to determine the semantic meaning of content of the data item to thereby determine the most appropriate classification label. This is useful because even if a data item contains a certain phrase which might suggest that a certain classification label is relevant, the overall meaning of the content of the data item may indicate that a different classification label is more relevant. For example, an email may contain one phrase that relates to finance (suggesting the email should be classified with a “finance” label), but the overall meaning of the whole email may be about an employee's performance, so the email should be classified with a “human resources” label. Standard rules-based on expression matching techniques are unable to pick-up on this important difference between phrases and overall semantic meaning.

The uncategorised data items are obtained from at least one data source within the environment. The or each data source may be any computing device within the environment. Examples of computing devices include laptops, desktop computers, smartphones, servers, and so on. More generally, the at least one data source may be any data storage within the environment, which includes file servers and any cloud-based data storage, such as those provided by Microsoft SharePoint, Google Drive, and so on.

An embedding is a representation of values or objects, like text, images or audio, that can be understood and processed by machine learning models. An embedding usually takes the form of a vector, and thus the terms “embedding” and “embedding vector” are used interchangeably herein. An embedding is therefore a mathematical representation of a data item (e.g. text, image, video, audio, etc.), and may represent some or all of the content of the data item. For example, an embedding may represent the semantic meaning of a data item. Embeddings make it possible for machine learning models to understand the relationships between different data items. Embeddings are normally analysed within embedding space, i.e. a mathematical space in which similar items are positioned closer to one another than less similar items. For example, if embedding A for data item A is close to embedding B for data item B in embedding space, then data item A and data item B are similar in some way. For example, data item A may be a personnel file for an employee within an organisation, while data item B may be a job application from a candidate for a job within the organisation. Since both data items contain personal information about people, they may both be considered similar. In contrast, embeddings A and B may be far away from embedding C for data item C. Data item C may be a finance report created by a finance team within the organisation. Data item C contains different information to data items A and B, so it considered to be dissimilar.

Advantageously, by using an embedding model (machine learning model) to generate at least one embedding vector for non-labelled (i.e. uncategorised) data items, non-labelled data items are automatically processed and classified. As noted above, once the at least one embedding vector is generated for each uncategorised data item, the embedding vectors are clustered (in embedding space), based on how similar the embedding vectors are to each other. Embedding vectors which are clustered together in embedding space uncategorised data items which are similar to each other. Once clustered, an LLM is used to generate at least one classification label that best relates to each cluster. LLMs are advantageous for being able to digest and analyse large amounts of data and spot patterns. Thus, using LLMs allows their power to be harnessed to quickly and automatically or semi-automatically identify labels for uncategorised data items. This is also useful because it does not require an organisation to specify a list of labels which are to be used to classify uncategorised data items. Manually-generated lists of labels may be generated ‘blind’ by a human user, i.e. without knowing exactly what all the data items being labelled relate to, or only knowing what some data items may relate to. This means the manually-generated labels may be incomplete or inaccurate or may need to change over time, i.e. they may not accurately define the data items now or in the future. Thus, it is advantageous to use an LLM to help generate the labels. Two different ways to generate the labels are described below and herein. Once the at least one classification label is generated for a cluster, the at least one classification label can be applied to all the data items in the cluster, to thereby generate labelled data items.

In some cases, each label may be assigned to or associated with at least one data management policy that is appropriate for that class/category. In such cases, once the uncategorised data items have been categorised and labelled, the appropriate security policy or policies can be quickly retrieved and used. This allows data management policies to be applied to new data items immediately rather than periodically when done manually, which improves data security and confidentiality.

As noted above, at least one classification label may be generated for each cluster, where the label is/labels are specific to the content of the data items in the cluster. The word “specific” means that the label is descriptive of the content type or data type of the data items in the cluster. In some cases, a single classification label may be generated for each cluster. In other cases, two or more classification labels may be generated for each cluster, where each label is specific to the content. This may occur when there are multiple possible, and equally valid, labels for content. For example, the labels “marketing” and “business development” may be generated for a cluster in which all the data items are related to activities concerning business development and marketing. Thus, sometimes the multiple labels may be synonyms. In this case, it may be desirable to select one of the labels to use. In another example, the labels may not be synonyms. For example, the labels “invoices” and “tax” may be generated for data items in a cluster that are related to invoice queries or tax queries, or invoices that include a tax breakdown. Similarly, the labels “photographs” and “people” may be generated for data items that are photographs that contain people. In these cases, both labels may be equally applicable. Alternatively, the generation of two or more labels which are not synonyms may indicate the clustering needs to be redone as the data items are not similar enough.

The step of obtaining a plurality of uncategorised data items may comprise obtaining any one or more of: an email, a document, a file, a text file, a folder, an image, a video, an audio file, a diagram, a geographical map, a medical image, a medical data file, a portable document format file, and any other specialised file type. It will be understood that this is a non-exhaustive and non-limiting list of example data item types.

The step of clustering the plurality of uncategorised data items may comprise using any one of: a data clustering algorithm, a k-means clustering algorithm, and a density-based spatial clustering algorithm. K-means clustering is the simplest and most commonly used clustering algorithm for high dimensional data. It partitions the data into K clusters, where each data point belongs to the cluster with the nearest mean. DBSCAN (Density-Based Spatial Clustering of Applications with Noise) is an algorithm that is based on the density of data points in a region. It groups together data points that are close to each other in the data space. Hierarchical clustering is an algorithm that creates a hierarchy of clusters by either a bottom-up or top-down approach. It is useful for understanding the structure of the data and can handle high dimensional data well. Spectral clustering is an algorithm uses the eigenvalues of a similarity matrix to reduce the dimensionality of the data before applying a clustering algorithm like k-means. Mean shift clustering is an algorithm that works by updating candidates for centroids to be the mean of the points within a given region. It is not sensitive to the initial placement of centroids. It will be understood that this is a non-exhaustive and non-limiting list of example clustering algorithms that could be used to perform the clustering.

In some cases, a single embedding vector may be generated for each uncategorised data item. This may be possible when the data item is small or when the whole of the data item relates to a single topic such that one embedding vector is sufficiently representative of all the content and semantic meaning within the data item. In such cases, clustering the plurality of uncategorised data items may comprise clustering each embedding vector in embedding space, and thereby clustering the plurality of uncategorised data items into a plurality of clusters.

In other cases, the method may further comprise: prior to generating at least one embedding vector, dividing the uncategorised data item into two or more segments; and generating the at least one embedding vector for each of the two or more segments. That is, in cases where the data item is large, a single embedding vector generated for the data item may not be very representative of all the content and semantic meaning within the data item. Thus, it may be useful to divide the data item into smaller chunks or segments, such that the generated embedding vectors capture the semantic meaning of the segments. For example, an image may be divided into image patches or segments, a video may be divided into segments containing one or more frames, and an audio file may be divided into smaller audio segments. The segments may be overlapping. It will be understood that any suitable way of dividing the data item may be used.

Preferably, the method may further comprise: calculating an average embedding vector for each uncategorised data item by averaging the embedding vector generated for each segment of the data item; wherein clustering the plurality of uncategorised data items comprises clustering the average embedding vectors in embedding space, and thereby clustering the plurality of uncategorised data items into a plurality of clusters. In other words, the embedding vectors generated for the segments are averaged in some way to create a single average embedding vector for the whole uncategorised data item. As explained in more detail below with respect to the Figures, to prevent data skew, the method may comprise performing an anomaly detection step prior to performing the calculation of the average embedding vector. That is, the anomaly detection may determine whether any of the embedding vectors generated for the segments of the data item are very different to the others in value(s) or in terms of their location in embedding space. If any of the embedding vectors are different (i.e. are outliers), then they may skew the average embedding vector for the whole data item, and thereby cause the data item to be incorrectly classified. Thus, by identifying any outliers and discounting/discarding them when calculating the average embedding vector for a data item, the accuracy of the classification process may be improved. It will also be understood that any averaging technique, such as the mean, may be used to perform the averaging.

In some cases, the step of generating at least one embedding vector may comprise: extracting text content from the uncategorised data item; and generating at least one embedding vector for the extracted text content. Thus, the embedding vector(s) may be generated based on textual information within the uncategorised data item. If the uncategorised data item is, for example, an image or video, text may be extracted from the image or frames of the video. Additionally or alternatively, for videos or audio files, a transcript of any speech contained within the video/audio file may be extracted.

In cases where text content is extracted from the uncategorised data item, the method may further comprise: prior to the generating, translating the extracted text into a pre-defined natural language. A natural language is any language used by humans, as opposed to, for example, computer programming languages. The pre-defined natural language may be a human language that is selected or determined in advance, and may be linked to the language used to train the embedding model. The translation may be required because the embedding model may have been trained using data items in one or more specific natural languages, such as English. The embedding model may not be able to process text in other languages, and therefore, the translation enables the embedding model to generate embedding vectors for data items that may contain other natural languages. Any suitable technique may be used to perform the translation. For example, the translation may be performed using machine translation techniques, which may utilise a large language model or other natural language processing mechanism.

The method may further comprise: prior to the generating, dividing the extracted text content into two or more segments; wherein generating the at least one embedding vector comprises generating an embedding vector for each of the two or more segments. That is, in cases where the extracted text is long, a single embedding vector generated for the extracted text may not be very representative of all the content and semantic meaning within the text. There are two main reasons to divide the extracted text into chunks. One is that the context window of many embedding models is limited. For example, for OpenAI, the context window is 8 k tokens (i.e. words), and for some open-source models, it can be as low as 512 tokens (words). So, it is necessary to reduce the amount of text that is fed into the embedding model to generate the embedding vector. Another reason is that reducing the number of tokens (words) and limiting those tokens to be within the same page or paragraph, improves the accuracy of the semantic extraction. This is because the semantic meaning is better determined for shorter text segments. To avoid a loss of context, the division may comprise dividing the text content into overlapping segments, to avoid loss of context between segments. Thus, it may be useful to divide the extracted text into smaller chunks or segments, such that the generated embedding vectors capture the semantic meaning of the segments. The extracted text may be divided into pages, paragraphs, or into segments of a certain number of words. It will be understood that any suitable way of dividing the text may be used. Dividing the extracted text content into segments is also known as “chunking”.

In some cases, generating at least one embedding vector comprises: generating text content for the uncategorised data item; and generating at least one embedding vector for the generated text content. This may be useful for uncategorised data items that do not contain any text that can be extracted. The generated text content may be a description or summary of the non-text content of the uncategorised data item. For example, if the uncategorised data item is an image (e.g. photograph, frame of a video, medical image, graph, schematic diagram, flowchart, diagram, etc.), the generated text content may summarise the meaning and content of the image. A large language model, LLM, may be used to generate the text content, for example.

Additionally or alternatively, for uncategorised data items that do not contain any text that can be extracted, the at least one embedding vector may be generated for the non-text content of the data item. That is, the embedding model may be a multi-modal embedding model able to process multiple types of input data, and generate an embedding vector representing some or all of the content of the data item. For example, the embedding model may be able to generate an embedding vector representing features of an image or audio file. Alternatively, different single-modality embedding models may be used to process different types of input data. For example, one embedding model may be used to process text, another to process images or video frames, another to process audio, and so on. With respect to images, an image embedding model may be used. Image embedding models may receive an image, extract features from that image, and generate an embedding vector to represent the extracted features. Non-limiting examples of image embedding models include VisualBERT and vit-base-beans. With respect to images, images may not be divided into segments, but instead, if the image is too large to be processed by the embedding model, the image may be downscaled before being input into the embedding model. Any suitable downscaling technique may be used.

As mentioned above, there are at least two ways of generating classification labels for the clustered uncategorised data items. Two ways are now described.

In one example, the step of generating, using a large language model, at least one classification label may comprise: analysing the uncategorised data items in each cluster to determine at least topic representative of content of the subset of the plurality of uncategorised data items in the cluster. A topic is a description of the common features or themes of the uncategorised data items in each cluster. For example, a topic may describe common keywords or phrases extracted from the data items in each cluster. For instance, if the words “confidential”, “attachments”, and “intended recipient” are extracted from data items, a topic describing these words may be “professional and confidential communication” because the words suggest the data items are business-specific and contain sensitive information.

A topic model may be used to discover the topic(s) in each cluster. Topic models may be trained machine learning models which focus on how often words occur and co-occur within each data item. The models may group commonly co-occurring words into sets of topics. For example, if the words “confidential”, “attachments”, and “intended recipient” appear/occur together frequently, then these words may be grouped together to form a topic. There are many types of topic model. For example, a correlation explanation (CorEx) algorithm may be used to discover topics that are informative about the data items in each cluster. The CorEx algorithm (as described in, for example, Discovering Structure in High-Dimensional Data Through Correlation Explanation—Greg Ver Steeg and Aram Galstyan, NIPS 2014, http://arxiv.org/abs/1406.1222; and Maximally Informative Hierarchical Representations of High-Dimensional Data—Greg Ver Steeg and Aram Galstyan, AISTATS 2015, http://arxiv.org/abs/1410.7404) may be applied to each cluster, one-by-one. It will be understood that other techniques or algorithms or topic models may be used to discover topics that are descriptive of the uncategorised data items in each cluster. Non-limiting examples of other techniques include Latent Dirichlet Allocation (LDA) and Non-Negative Matrix Factorisation (NMF).

In this example, the method may further comprise specifying a maximum number of topics to be generated for the plurality of uncategorised data items. For example, when using the CorEx algorithm, the number of topics (k) need to be input into the algorithm, and CorEx will then analyse the documents and categorize them into k topics.

In this example, the step of generating, using a large language model, at least one classification label may comprise: inputting the at least one topic for each cluster into the large language model, LLM; and obtaining for each topic, from the LLM, at least one classification label and a description of the topic. That is, an LLM may be used to generate a more detailed description of each topic. To do so, anchor words from each topic may be input into the LLM, and the LLM may output a coherent and comprehensive description of the topic based on the anchor words. The result will be a set of k topics, each with a detailed description provided by the LLM. Anchor words are a type of guidance given to the LLM to influence the topics it generates. Anchor words are essentially seed words that are strongly associated with a specific topic. By specifying anchor words, it is possible to guide the LLM to form topics around certain themes. This is particularly useful when prior knowledge about the data items exists and it is desirable to ensure that certain topics are captured by the LLM.

In another example, the step of generating, using a large language model, at least one classification label may comprise: selecting a sample of uncategorised data items from the cluster; inputting the sample of uncategorised data items into the large language model, LLM together with at least one prompt to instruct the LLM to output at least one classification label; and obtaining, from the LLM, at least one classification label for the input sample of uncategorised data items. In this example, compared to the example above, the step of generating a topic is bypassed. Instead, the LLM is used to directly generate a classification label or labels for each input sample of uncategorised data items. In other words, a sample of documents is input into an LLM (commercial or open source), and prompt engineering is used to extract the best fitting category or label for those input sample documents.

In this example, the method may further comprise: inputting, into the LLM, a maximum number of classification labels to be generated by the LLM. Thus, the LLM may be promoted to generate a high-level category/label or a specific number of labels, to prevent too many labels being generated. For example, one unique label per data items would not be a useful way to categorise all of the uncategorised data items because no actions can then be taken or policies applied to a whole group of data items with the same labels. The maximum number of classification labels may be configurable based on the environment or user-specific requirements.

In this example, the method may further comprise: inputting, into the LLM, at least one further prompt to ensure the at least one classification label complies with predefined responsible AI guidelines. This prompt may contain a set of strict guidelines to make sure that the LLM does not violate any Responsible AI rule such as ensuring the outputs of the LLM are not discriminatory or racist. Furthermore, the LLM may be able to return only one of the predefined categories, which will be validated upon the return of the result before the categories can be applied to the uncategorised data items as labels. Thus, in some cases, the LLM may be provided with predefined categories/labels or explanations of what may be used as a category/label, so that the LLM does not output anything it thinks is a category/label. In other words, there may be some constraints on the LLM in terms of what can be output as a category/label. This may improve overall accuracy of the LLM's outputs for the task, and may improve compliance with responsible AI guidelines.

Preferably, a low temperature parameter may be used to make sure that the LLM is more deterministic, with low creativity. That is, it is desirable to prevent the LLM from being too creative, and to instead be more predictable, because it is desirable to obtain the same topics and/or classification labels and/or descriptions each time the same data items are processed by the LLM. Certain LLMs have a temperature parameter, typically ranging from 0 to 2. This parameter controls how deterministic the outputs of the LLM are. A lower temperature results in more predictable responses, while a higher temperature can produce more varied answers.

The method may further comprise: storing, in a database, the generated embedding vectors and associated cluster, topic and classification label. That is, once the new classification labels have been generated, some or all of the generated embedding vectors may be added to a database. The embedding vectors added to the database may be added in addition to the associated cluster, topic (if generated) and classification label. If any data items have not been categorised, these data items remain in a separate database of uncategorised data items until it is possible to identify a cluster for them. That is, when data items do not cluster with other data items, they are not categorised because there is insufficient information about those data items. This ensures that outliers are not categorised on a one-by-one basis, for the sake of efficiency and also accuracy of labelling/categorising.

The method may further comprise: obtaining a new uncategorised data item; generating at least one embedding vector for the new uncategorised data item; comparing the generated at least one embedding vector to the database of stored embedding vectors; selecting, responsive to the comparing, at least one stored embedding vector that is most similar to the generated at least one embedding vector for the new uncategorised data item; and applying to the new uncategorised data item, at least one classification label corresponding to the selected at least one stored embedding vector, thereby generating a new labelled data item.

Comparing the generated at least one embedding vector to the database of stored embedding vectors may comprise: calculating a cosine similarity between the generated at least one embedding vector and each stored embedding vector. Cosine similarity is a measure of the similarity between two vectors, and is calculated by determining the cosine of the angle θ between the two vectors. When θ is close to 0°, cosine θ is close to 1, which means the vectors are similar; when θ is close to 90°, cosine θ is close to 0, which means the vectors are orthogonal; and when θ is close to 180°, cosine θ is close to −1 which means the vectors are opposite.

Selecting at least one stored embedding vector that is most similar to the generated at least one embedding vector may comprise: selecting at least one stored embedding vector that is within a predefined threshold distance in embedding space from the generated at least one embedding vector. For example, the cosine similarity may be used to determine which stored embedding vector is most similar to each embedding vector. Additionally or alternatively, each stored embedding vector within a predefined threshold distance (e.g. having a cosine θ value in a certain range), may be considered similar to the generated embedding vector.

In some cases, applying, to the new uncategorised data item, the classification label corresponding to the selected at least one stored embedding vector may comprise: applying a single classification label to the uncategorised data item. That is, each uncategorised data item is labelled within a single classification label that is most representative of the data item or information contained within the data item.

Alternatively, applying, to the uncategorised data item, the classification label corresponding to the selected at least one stored embedding vector may comprise: applying multiple classification labels to the uncategorised data item when multiple stored embedding vectors are selected. In such cases, multiple classification labels may be necessary to fully represent the data item or information contained within the data item. This may occur in cases where the extracted text has been divided into segments and each segment results in a different classification label being applied. Alternatively, this may occur when the data item corresponds to multiple labels. For example, the data item may be an email, and “email” may be a label, but the content of the email may be confidential, and “confidential” may be a label. In this case, it is appropriate to apply two labels to the data item.

In cases where a labelled data item has multiple labels, retrieving at least one security policy for the labelled data item may comprise: retrieving a security policy corresponding to each label of the multiple classification labels applied to the non-labelled data item; and determining which security policy or policies to apply to the labelled data item. Continuing with the above example, for a data item that is labelled with “email” and “confidential”, two data management policies may be retrieved-one for “email”, and one for “confidential”. The “email” security policy may relate to data retention, i.e. how long the email needs to be retained within the environment. The “confidential” policy may dictate who within the environment is able to access, read and/or edit the data item, and who is prevented from doing so. In this case, both policies may be applied to the data item without any conflict. However, in cases where the data management policies conflict or contradict with each other, it may be necessary to determine which data management policy to use, or how to use all of the retrieved policies. In some cases, the strictest data management policy of the retrieved policies may be applied.

The method may further comprise: outputting information explaining how the at least one classification label of the new labelled data item is determined.

In cases when none of the stored embedding vectors are similar to the generated at least one embedding vector for the new uncategorised data item, the method may comprise: storing, in a second database, the new uncategorised data item. The second database may be the same database where all the previously uncategorised data items are stored.

The method may further comprise performing the clustering when the second database contains a predefined threshold number of new uncategorised data items. That is, the second database is analysed when a predefined threshold number of uncategorised data items exist, for the sake of efficiency. Specifically, when the second database contains a predefined threshold number of new uncategorised data items, the method may further comprise clustering, using the generated at least one embedding vector for each new uncategorised data item, the new uncategorised data items into a plurality of clusters, where each cluster contains a subset of the new uncategorised data items that are more similar to each other than to the new uncategorised data items in other clusters.

In a second approach of the present techniques, there is provided a system for autonomously classifying uncategorised data items within an environment, the system comprising: a plurality of data sources within the environment; and a plurality of processors, each processor being coupled to one of the plurality of data sources and configured for: obtaining, from the data source, a plurality of uncategorised data items; generating, using a machine learning, ML, model, at least one embedding vector for each uncategorised data item, where the at least one embedding vector represents content of each uncategorised data item; clustering, using the at least one embedding vector generated for each uncategorised data item, the plurality of uncategorised data items into a plurality of clusters, where each cluster contains a subset of the plurality of uncategorised data items that are more similar to each other than to the uncategorised data items in other clusters; generating, using a large language model, LLM, at least one classification label for each cluster, wherein the at least one classification label is specific to content of the subset of the plurality of uncategorised data items in the cluster; and applying, to each uncategorised data item in each cluster, the at least one classification label generated for the cluster, thereby generating a labelled data item.

The system may further comprise a remote server configured for: receiving, from the plurality of processors, the generated at least one embedding vector for each uncategorised data item; generating a combined set of embedding vectors representative of data items in the environment; and transmitting, to the plurality of processors, the combined set of embedding vectors, for use when categorising new uncategorised data items. That is, because each processor performs the categorisation with respect to one of the plurality of data sources, it may only see limited types of data items, and may not know how to categorise other types of data item that are less common or uncommon in that particular data source. Sharing the set of embedding vectors that are generated by all the processors with all the processors means that each processor has more information to use when recategorisation needs to be performed or categorisation of new uncategorised data items needs to be performed.

The features described above with respect to the first approach apply equally to the second approach and therefore, for the sake of conciseness, are not repeated.

In a third approach of the present techniques, there is provided a computer-implemented method for creating a classification database, the method comprising: obtaining, from at least one data source within the environment, a plurality of uncategorised data items; generating, using a machine learning, ML, model, at least one embedding vector for each uncategorised data item, where the at least one embedding vector represents content of each uncategorised data item; clustering, using the at least one embedding vector generated for each uncategorised data item, the plurality of uncategorised data items into a plurality of clusters, where each cluster contains a subset of the plurality of uncategorised data items that are more similar to each other than to the uncategorised data items in other clusters; generating, using a large language model, LLM, at least one classification label for each cluster, wherein the at least one classification label is specific to content of the subset of the plurality of uncategorised data items in the cluster; applying, to each uncategorised data item in each cluster, the at least one classification label generated for the cluster, thereby generating a labelled data item; and storing, in a database, the generated at least one embedding vector and associated classification label for each cluster. In some cases, the classification database is for determining a data management policy for a data item.

As noted above, the first and second approaches may lead to the generation of a classification database, which can be used to automatically categorise new uncategorised data items. The third approach relates to how this classification database is generated so that it can be used to, for example, determine, automatically, a data management policy for new unlabelled data items within an environment. Advantageously, the classification database may be generated for a specific environment (e.g. workplace or organisation), so that the database is relevant to the types of data items within that environment and the types of labels and data management policies that need to be used within that environment.

The features described above with respect to the first approach apply equally to the third approach and therefore, for the sake of conciseness, are not repeated.

In a fourth approach of the present techniques, there is provided a system for creating a classification database, the system comprising: a plurality of data sources; and a plurality of processors, each processor being coupled to one of the plurality of data sources and configured for: obtaining, from the data source, a plurality of uncategorised data items; generating, using a machine learning, ML, model, at least one embedding vector for each uncategorised data item, where the at least one embedding vector represents content of each uncategorised data item; clustering, using the at least one embedding vector generated for each uncategorised data item, the plurality of uncategorised data items into a plurality of clusters, where each cluster contains a subset of the plurality of uncategorised data items that are more similar to each other than to the uncategorised data items in other clusters; generating, using a large language model, LLM, at least one classification label for each cluster, wherein the at least one classification label is specific to content of the subset of the plurality of uncategorised data items in the cluster; applying, to each uncategorised data item in each cluster, the at least one classification label generated for the cluster, thereby generating a labelled data item; and storing, in a database, the generated at least one embedding vector and associated classification label for each cluster. In some cases, the classification database is for determining a data management policy for a data item.

The features described above with respect to the first approach apply equally to the fourth approach and therefore, for the sake of conciseness, are not repeated.

In a fifth approach of the present techniques, there is provided a computer-implemented method for controlling actions performed with respect to a data item, the method comprising: obtaining, from at least one data source within the environment, a plurality of uncategorised data items; generating, using a machine learning, ML, model, at least one embedding vector for each uncategorised data item, where the at least one embedding vector represents content of each uncategorised data item; clustering, using the at least one embedding vector generated for each uncategorised data item, the plurality of uncategorised data items into a plurality of clusters, where each cluster contains a subset of the plurality of uncategorised data items that are more similar to each other than to the uncategorised data items in other clusters; generating, using a large language model, LLM, at least one classification label specific to content of the subset of the plurality of uncategorised data items in the cluster; applying, to each uncategorised data item in each cluster, the at least one classification label generated for the cluster, thereby generating a labelled data item; retrieving, for each generated labelled data item, a least one data management policy corresponding to the at least one classification label of the labelled data item; and using the at least one data management policy to control an action performed with respect to the generated labelled data item.

Advantageously, the present techniques enable actions to be automatically and immediately applied to, or with respect to, an uncategorised data item once it has been labelled and at least one appropriate data management policy has been identified.

The features described above with respect to the first approach apply equally to the fifth approach and therefore, for the sake of conciseness, are not repeated.

The applying step may comprise applying multiple classification labels to each uncategorised data item, for the same reasons as those described above. In this case, retrieving at least one data management policy for the labelled data item may comprise: retrieving a data management policy corresponding to each classification label of the multiple classification labels applied to the uncategorised data item; and determining which data management policy or policies to use to control actions performed with respect to the labelled data item.

In some cases, where the retrieved policies do not conflict or contradict with each other, the determining may comprise determining that all of the retrieved policies can be used. For example, one of the retrieved policies may relate to data retention and one may relate to access, and both of these policies can be applied. In cases where the retrieved policies conflict or contradict each other, determining which data management policy or policies to use to control actions performed with respect to the labelled data item may comprise: selecting the most strict data management policy from the data management policies corresponding to the multiple labels. The strictness of a policy may depend on what the policy relates to. For example, if a policy allows access for one classification, but denies another, then “deny” could be the resultant action. For data retention, if one classification requires data to be kept for 1 year, and another classification for 2 years, the longest retention period will be chosen. If one classification allows access without producing an audit record and another allows access but requires audit record, then an audit record should be produced.

The method may further comprise: receiving an override instruction to ignore one or more of: a label applied to the labelled data item, and a data management policy associated with a label applied to the labelled data item. Thus, an administrator of the system may be able to override a data management policy associated with a labelled data item.

Using the at least one data management policy to control an action performed with respect to the labelled data item may comprise: receiving a request to perform an action with respect to the labelled data item; determining, using the at least one data management policy, whether the request should be granted; and granting the request to perform the action with respect to the labelled data item responsive to the determining. For example, a user of the system may attempt to delete a labelled data item. The data management policy(ies) associated with the labelled data item may determine whether the labelled data item can be deleted. For example, a data management policy may specify that the labelled data item has to be retained within the system for a period of five years. If the labelled data item has existed in the system for less than five years, the request to delete the labelled data item will not be granted in view of the data management policy. In another example, a user of the system may attempt to read a labelled data item which is associated with a data management policy that restricts access to specific users. The user's request may only be granted if they are listed as a user that is permitted access.

Using the at least one data management policy to control an action performed with respect to the labelled data item may comprise controlling any one or more of: accessing, reading, modifying, editing, sharing, archiving, deleting, distributing within the environment, and distributing external to the environment. It will be understood that this is a non-exhaustive list of example actions that could be performed with respect to a labelled data item. The action may be performed by a separate access management system.

In a sixth approach of the present techniques, there is provided a system for controlling actions performed with respect to a data item, the system comprising: a plurality of data sources; and a plurality of processors, each processor being coupled to one of the plurality of data sources and configured for: obtaining, from at least one data source within the environment, a plurality of uncategorised data items; generating, using a machine learning, ML, model, at least one embedding vector for each uncategorised data item, where the at least one embedding vector represents content of each uncategorised data item; clustering, using the at least one embedding vector generated for each uncategorised data item, the plurality of uncategorised data items into a plurality of clusters, where each cluster contains a subset of the plurality of uncategorised data items that are more similar to each other than to the uncategorised data items in other clusters; generating, using a large language model, LLM, at least one classification label specific to content of the subset of the plurality of uncategorised data items in the cluster; applying, to each uncategorised data item in each cluster, the at least one classification label generated for the cluster, thereby generating a labelled data item; retrieving, for each generated labelled data item, a least one data management policy corresponding to the at least one classification label of the labelled data item; and using the at least one data management policy to control an action performed with respect to the generated labelled data item.

The features described above with respect to the first approach and fifth approach apply equally to the sixth approach and therefore, for the sake of conciseness, are not repeated.

In a related approach of the present techniques, there is provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog® or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

### BRIEF DESCRIPTION OF THE DRAWINGS

Implementations of the present techniques will now be described, by way of example only, with reference to the accompanying drawings, in which:

FIG. 1 is a block diagram of a system for autonomously classifying uncategorised data items within an environment;

FIG. 2 is a block diagram of a document (data item) embedding pipeline, DEP;

FIG. 3 is a flowchart of example steps for autonomously classifying uncategorised data items within an environment;

FIG. 4 is a flowchart showing steps of one example technique for generating classification labels;

FIG. 5 is a flowchart showing steps of one example technique for generating classification labels; and

FIG. 6 is a flowchart of example steps to categorise new uncategorised data items after the initial learning dataset has been created.

### DETAILED DESCRIPTION OF THE DRAWINGS

Broadly speaking, the present techniques provide an automatic way of classifying data items within an environment (e.g. a business, workplace, organisation, etc.). This is advantageous over existing techniques which require manual classification of data items, which is time consuming in environments where hundreds of new data items may be generated in a day or week. The present techniques use an embedding machine learning, ML, model and an LLM to automatically determine the relevant classification label(s) for an unlabelled data item.

Manually categorizing company documents is a challenging and often impractical task due to several factors:
Volume: Companies generate vast amounts of data. From emails, reports, invoices, to contracts and technical documents, the sheer number of documents can be overwhelming. Manually reviewing each document for categorization is time-consuming and labour-intensive
Variety: Documents within an organization can be highly diverse, ranging across different formats (text, PDF, images, spreadsheets), languages, and subject matter. Understanding and accurately categorizing such a wide array of documents requires specialized knowledge and expertise, which may not be feasible to have in one individual or even a team.
Complexity: Many documents contain nuanced information that can be interpreted in various ways. Determining the appropriate category for such documents can be subjective and may require context that is not immediately apparent, leading to inconsistencies in categorization.
Human Error: Manual categorization is prone to errors due to fatigue, misinterpretation, or oversight. Consistency in categorization is hard to maintain over large datasets when multiple individuals are involved, each with their own understanding and interpretations.
Maintainability: As new documents are continuously created, keeping the categorization up-to-date manually becomes an ongoing challenge. Additionally, the categorization system may need to evolve as business needs change, requiring constant attention and revision.

For at least these reasons, an automated categorization solution is required.

As mentioned above, existing document classification systems using rules or regular expressions. Data loss prevention, DLP, systems use classification labels to monitor sensitive data, block suspicious operations within an organisation/environment, and enforce data access policies. Other techniques perform document classification according to a given learning set and categories. In contrast, the present techniques advantageously provide an autonomous process for category discovery with zero friction caused to the user or system administrator.

A high-level description of the present techniques is now provided. The present techniques involve scanning all company documents. During the scanning process, autonomous document clustering is performed using semantic similarity and clustering algorithms, such as K-means, DBScan and others. This may be done with Auto-ML, i.e. Automated Machine Learning, which refers to the process of automating an end-to-end process of applying machine learning. This process includes tasks such as data preprocessing (i.e. cleaning and preparing data for modelling, feature engineering (i.e. automatically creating and selecting the most relevant features from the raw data), model selection (i.e. choosing the best machine learning model or algorithm for a given task), hyperparameter tuning (i.e. automatically finding the optimal settings for the chosen model to improve its performance), model training (i.e. training the selected model on the prepared data), and model evaluation (i.e. assessing the model's performance using various metrics to ensure it meets the desired criteria). In other words, Auto-ML may be used to perform the document clustering process.

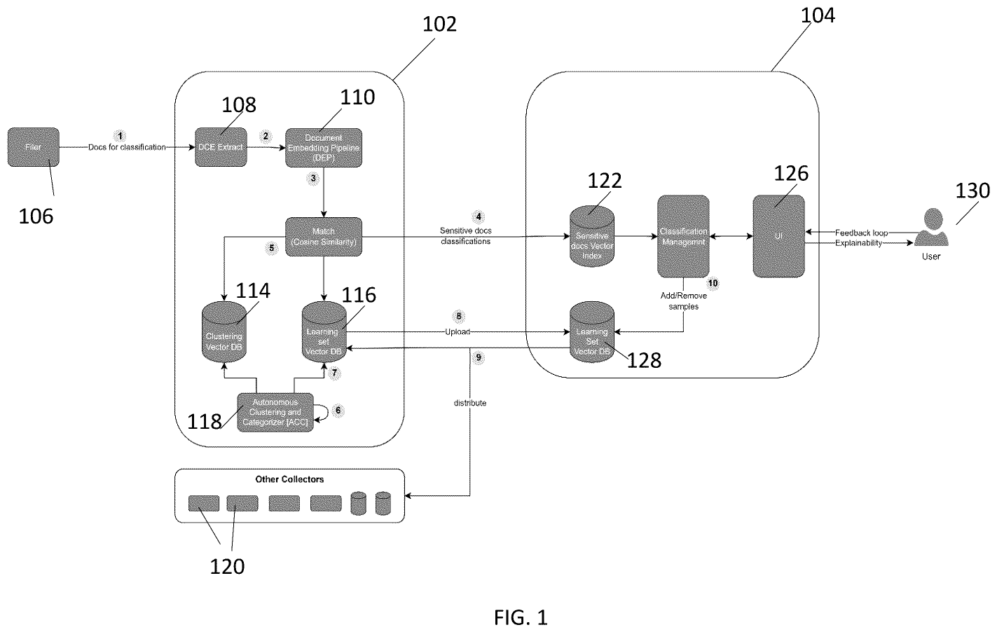

As noted above, Auto-ML includes data preprocessing, feature engineering, and model selection processes. The Auto-ML method may automatically explore algorithms and configurations, and automatically decides on hyperparameter tuning (for example—deciding the optimal K in K-means). This removes the need for highly skilled data scientists and ML engineers. Once the documents are clustered, the Auto-ML method may extract the main topics from a sample of documents within each cluster and assigns a category to that specific cluster using either topic analysis, Large Language Models (LLM), or both. This sampling and clustering process is iterative and may be triggered when the number of uncategorized documents reaches a threshold of [T] (configurable threshold, e.g. 1,000). That is, the uncategorised documents are those which have not been clustered into an existing cluster according to a pre-defined minimal similarity score threshold. FIG. 1, discussed in more detail below, illustrates that an autonomous classification system may incorporate a feedback loop and an explainability mechanism, allowing users to review a classified document and receive clarification regarding the basis for its classification. Should a user dispute the classification, the system will display the most relevant section of a reference document (be it a page, paragraph, etc.) that influenced the classification decision. Users have the option to challenge the classification by requesting the exclusion of the reference document from the learning set. Subsequently, the system will conduct an impact analysis, providing the user with insights into which documents were categorized using that particular reference document. This enables users to comprehend the ramifications of their request. Following the removal of the reference document, during subsequent scans, the system will reclassify affected documents based on alternative reference documents.

The present techniques are now described in more detail with respect to the Figures.

FIG. 1 is a block diagram of a system 100 for autonomously classifying uncategorised data items within an environment, such as within a business, workplace, organisation, department within an organisation, etc. The system 100 comprises a plurality of data sources (not shown here) within the environment. The or each data source may be any computing device within the environment. Examples of computing devices include laptops, desktop computers, smartphones, servers, and so on. More generally, the at least one data source may be any data storage within the environment, which includes file servers and any cloud-based data storage, such as those provided by Microsoft SharePoint, Google Drive, and so on.

The system 100 also comprises a plurality of data collectors 102, 120 (also referred to as “collectors” herein). A data collector is an application, which may run on a server or other computer, and is able to collect data items, and enable data analysis to be performed on the collected data items. For example, the data collector may run on on-site file servers in the environment. Additionally or alternatively, the data collector may run on cloud-based file servers (such as Google Drive), and retrieve documents stored there. As the system 100 comprises a plurality of data sources, the system 100 may also comprise a plurality of collectors. The number of collectors may be equal to, or may not be equal to, the number of data sources in the system 100. In one example, multiple data sources may be linked to a collector. For example, the environment may be a law firm, and the law firm may have a number of departments, such as accounting, HR, marketing, and legal, and each department may contain a plurality of data sources, and each department's data sources may be connected to a single collector.

The system 100 comprises a plurality of processors (not shown here). The collector 102 may comprise or be linked to one of the plurality of processors, and thus, each processor is coupled to at least one of the plurality of data sources. The processor of, or connected to, the collector 102 is configured to obtain uncategorised data items from the data source(s) to which the collector 102 is coupled, and perform steps to classify the obtained uncategorised data items.

In some cases, as shown here, the system 100 the plurality of collectors 102, 120 may be on-site, i.e. based within the environment, and some additional components 104 of the system may be located off-site, i.e. external to the environment. However, in other cases, not depicted here, there may be no such separation and all of the components of the system 100 may be provided either on-site or off-site.

The following description of the system largely relates to the steps performed by collector 102 to autonomously classify uncategorised data items. However, it will be understood that the same steps may be performed by other collectors of the system, such as the other collectors 120 which are coupled to other data sources within the environment.

The collector 102 may comprise a data classification engine 108. The data classification engine 108 may receive all the data items from the or each data source to which the collector 102 is connected. In some cases, all the data items generated or otherwise present in each data source are sent to, and collected by, the collector 102. Alternatively, all the data items are filtered by a filter 106, and only those which are deemed to require classifying are sent to the collector 102. For example, the filter 106 may filter data items that do not need classifying, such as binary files, and/or may filter data items that are very large (e.g. over a pre-defined MB in size), as classifying large data items may need to be done separately or differently for the purpose of accuracy. Documents for classification are sent to the data classification engine, DCE, 108 from the data source(s). In some cases, the DCE 108 automatically scans all of the data sources to which the collector 102 is connected, to automatically identify and obtain uncategorised data items for classification. The DCE 108 may perform a full scan or incremental scan.

The classification of uncategorised data items may involve classifying the data items based on their textual content. Thus, if the data item contains text content, the classification process may involve extracting the text content. If the uncategorised data item is, for example, an image or video, text may be extracted from the image or frames of the video. Additionally or alternatively, for videos or audio files, a transcript of any speech contained within the video/audio file may be extracted.

The DCE 108 may extract text from the identified/obtained uncategorised data items. The data items may be any of: an email, a document, a file, a text file, a folder, an image, a video, an audio file, a diagram, a geographical map, a medical image, a medical data file, a portable document format file, doc, docx, pdf, txt, csv, png, jpeg, and any other specialised file type. It will be understood that this is a non-exhaustive and non-limiting list of example data item types. For images such as png, jpeg and pdf, DCE 108 may perform OCR (Optical Character Recognition).

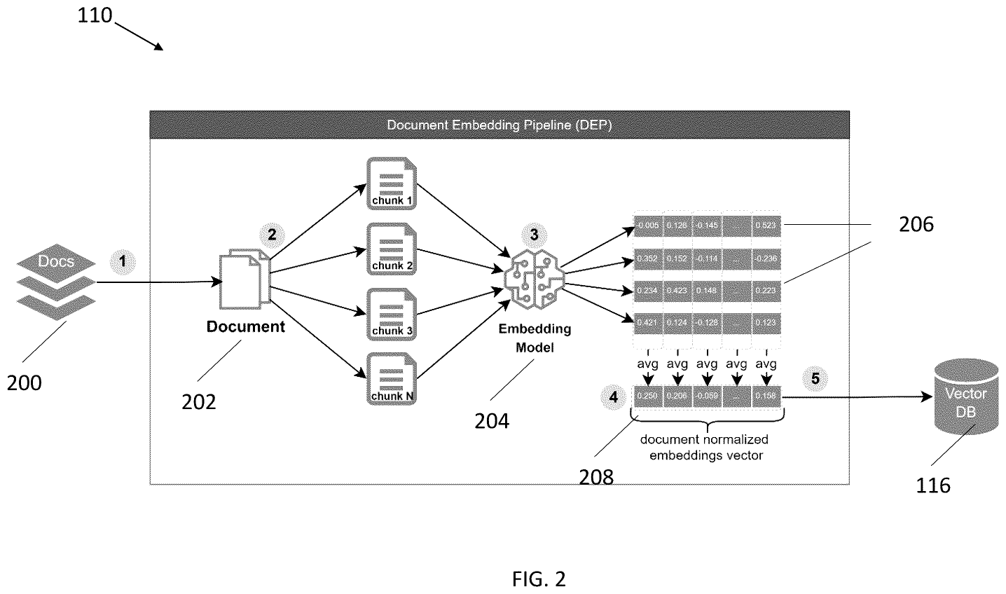

Once textual content has been extracted, at least one embedding vector is generated for each uncategorised data item using the extracted textual content. As shown in FIG. 1, the DCE 108 may transmit the extracted textual content to a document embedding pipeline, DEP, 110 of the collector 102. The DEP 110 is now described with respect to FIG. 2.

FIG. 2 is a block diagram of a document (data item) embedding pipeline, DEP 110. The method for autonomously classifying uncategorised data items within an environment comprises generating, using a machine learning, ML, model 204, at least one embedding vector for each uncategorised data item, where the at least one embedding vector represents content of each uncategorised data item. This generating step is described with respect to FIG. 2. Any suitable machine learning model 204 may be used to generate the embeddings, such as: OpenAI ADA-002 or Open-source State-Of-The-Art (SOTA) embeddings models such as AllMiniLM12, GritLM, Nomic, ParaphraseMiniLM. It will be understood that these are simply some non-limiting examples of models that could be used.

The DEP 110 receives a plurality of data items 200 for processing, and each data item 200 is processed separately. As shown in step 1, each data item 202 of the data items 200 is processed separately by the DEP 110.

In some cases, a single embedding vector may be generated by DEP 110 for each uncategorised data item 202. This may be possible when the data item 202 is small or when the whole of the data item 202 relates to a single topic such that one embedding vector is sufficiently representative of all the content and semantic meaning within the data item 202.

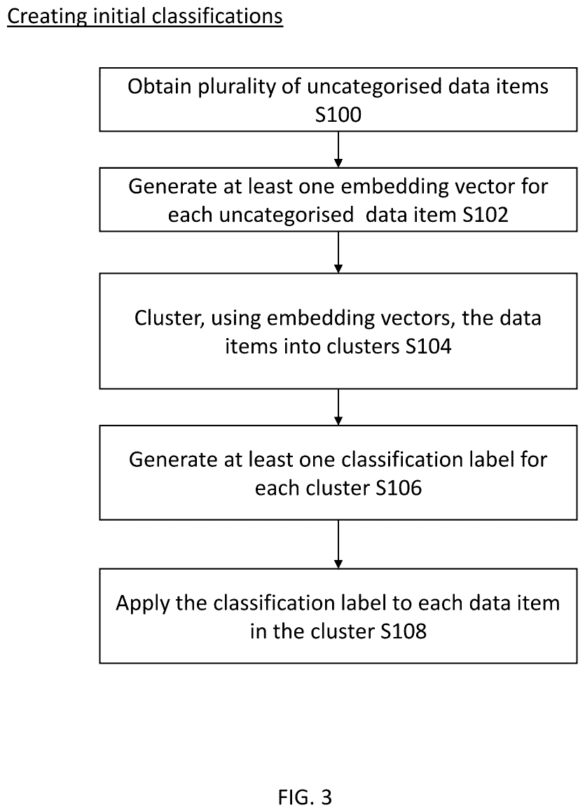

In other cases, the DEP 110 may, prior to generating at least one embedding vector, divide the uncategorised data item 202 into two or more segments (also referred to herein as “chunks”), as shown in step 2 of FIG. 2. The data item 202 may be split into chunks such as pages, paragraphs, or any other required chunking topology. Once the data item has been split into N chunks or segments, each chunk/segment is processed by the machine learning model 204. Thus, as shown at step 3 of FIG. 3, the ML model 204 may generate at least one embedding vector 206 for each of the two or more segments of data item 202. That is, in cases where the data item 202 is large, a single embedding vector generated for the data item may not be very representative of all the content and semantic meaning within the data item. Thus, it may be useful to divide the data item 202 into smaller chunks or segments, such that the generated embedding vectors capture the semantic meaning of the segments. For example, an image may be divided into image patches or segments, a video may be divided into segments containing one or more frames, and an audio file may be divided into smaller audio segments. The segments may be overlapping. It will be understood that any suitable way of dividing the data item may be used.

When the data item 202 has been split into segments, the DEP 110 may calculate an average embedding vector 208 for the uncategorised data item 202 by averaging the embedding vector 206 generated for each segment of the data item 202, as shown at step 4 of FIG. 2. All the chunks/segments of the data item may be normalized by calculating the average or max on each segment separately. This process creates a normalized embedding vector that represents the entire data item 202. This step may improve accuracy of the embedding vector generated for a data item by combining the semantic importance of all segments and reducing the importance of generally unimportant pages, such as an appendix or table of contents. In addition, to prevent data skew, the DEP 110 may use an anomaly detection algorithm to overcome outliers. The idea is that some chunks in the segmented data item might be very far-off from the overall semantics of the data item. For example, in an email, one paragraph may be a discussion about holidays and exchanging pleasantries with the recipient, but all the other paragraphs may be about a specific topic, such as a project/task update. Thus, the paragraph about holidays is unrelated to the topic of all the other paragraphs. Values of embedding vectors for the segments that are very far off from the overall mean can skew the average embedding vector. For example, given the following values to average 8, 10, 12, 6, 4, 100, there is an outlier (100) that increases the entire average and skews the results. Thus, an optional step prior to generating the average embedding vector is to detect and remove anomalies, i.e. embedding vectors for segments which are too different from the others for the same data item. Thus, the embedding vectors 206 generated for the segments are averaged in some way to create a single average embedding vector 208 for the whole uncategorised data item 202.

In cases where text content is extracted from the uncategorised data item 202, the DEP 110 may, prior to the generating of embedding vectors, translate the extracted text into a pre-defined natural language. A natural language is any language used by humans, as opposed to, for example, computer programming languages. The pre-defined natural language may be a human language that is selected or determined in advance, and may be linked to the language used to train the embedding model. The translation may be required because the embedding model 204 may have been trained using data items in one or more specific natural languages, such as English. The embedding model 204 may not be able to process text in other languages, and therefore, the translation enables the embedding model to generate embedding vectors for data items that may contain other natural languages. Any suitable technique may be used to perform the translation. For example, the translation may be performed using machine translation techniques, which may utilise a large language model or other natural language processing mechanism. Thus, DEP 110 optionally translates the data items or segments of the data items into a standard language (e.g. English), using an LLM or other mechanism.

In some cases, the ML model 204 may generate at least one embedding vector by: generating text content for the uncategorised data item; and generating at least one embedding vector for the generated text content. This may be useful for uncategorised data items that do not contain any text that can be extracted. The generated text content may be a description or summary of the non-text content of the uncategorised data item. For example, if the uncategorised data item is an image (e.g. photograph, frame of a video, medical image, graph, schematic diagram, flowchart, diagram, etc.), the generated text content may summarise the meaning and content of the image. A large language model, LLM, may be used to generate the text content, for example.

Additionally or alternatively, for uncategorised data items that do not contain any text that can be extracted, the at least one embedding vector may be generated by the ML model 204 for the non-text content of the data item. That is, the embedding model 204 may be a multi-modal embedding model able to process multiple types of input data, and generate an embedding vector representing some or all of the content of the data item. For example, the embedding model may be able to generate an embedding vector representing features of an image or audio file. Alternatively, different single-modality embedding models may be used to process different types of input data. For example, one embedding model may be used to process text, another to process images or video frames, another to process audio, and so on. With respect to images, an image embedding model may be used. Image embedding models may receive an image, extract features from that image, and generate an embedding vector to represent the extracted features. Non-limiting examples of image embedding models include VisualBERT and vit-base-beans. With respect to images, images may not be divided into segments, but instead, if the image is too large to be processed by the embedding model, the image may be downscaled before being input into the embedding model. Any suitable downscaling technique may be used.

The system 100 may comprise a vector database 116. As shown in FIG. 2 at step 5, the DEP 110 may comprise storing, in database 116, the generated embedding vectors 206 (or average embedding vectors 208 if the data item was divided into segments) for each data item 202. The vector database 116 may be used to help generate embedding vectors for any new uncategorised data items. The (normalized) embedding vector may be added to the VectorDB 116 in addition to other information, such as the document name (for the corresponding data item 202), path, timestamp, etc. as the additional information may help to audit the classification process, particularly if any data items are considered to be miscategorised.

Once the embedding vectors have been generated for the uncategorised data items, the system 100 clusters, using the at least one embedding vector generated for each uncategorised data item, the uncategorised data items into a plurality of clusters. Each cluster contains a subset of the plurality of uncategorised data items that are more similar to each other than to the uncategorised data items in other clusters. The clustering step may not happen each time embedding vectors are generated. Instead, for the purpose of efficiency, the embedding vectors corresponding to uncategorised data items (and potentially the data items themselves) may be stored in clustering database 114, and the clustering may only be performed when there is a threshold number of embedding vectors in the clustering database 114.

The system 100 generates, using a large language model, LLM, at least one classification label specific to content of the subset of the plurality of uncategorised data items in the cluster. There are at least two ways of generating classification labels for the clustered uncategorised data items. Two ways are now described.

In one example, topic extraction and analysis of all the data items is performed using CorEx (Correlation Explanation). This comprises doing the following, per cluster:
First apply CorEx algorithm to these data items. It may be necessary to specify the number of topics (k) the algorithm is to generate. CorEx will then analyse the data items and categorize them into k topics.
Get Topic Words: The CorEx algorithm will provide a set of anchor words for each topic. These words are the most representative or “core” words for each topic, and they provide a basic understanding of what each topic is about
Apply LLM: Finally, use a Large Language Model (LLM) to generate a more detailed description of each topic. Input the anchor words from each topic into the LLM, and the LLM will output a coherent and comprehensive description of the topic based on these words.
   The result will be a set of k topics, each with a detailed description provided by the LLM.

In other words, in this example, the step of generating, using a large language model, at least one classification label may comprise: analysing the uncategorised data items in each cluster to determine at least topic representative of content of the subset of the plurality of uncategorised data items in the cluster. A topic is a description of the common features or themes of the uncategorised data items in each cluster. For example, a topic may describe common keywords or phrases extracted from the data items in each cluster. For instance, if the words “confidential”, “attachments”, and “intended recipient” are extracted from data items, a topic describing these words may be “professional and confidential communication” because the words suggest the data items are business-specific and contain sensitive information.

For example, CorEx may output the following common keywords or phrases (also referred to herein as “topic words”) extracted from data items in a cluster. In this case, the algorithm may have been prompted to identify no more than 20 topics, and thus, 20 groups of common keywords/phrases are identified:
1: que, en, la, para, el, este, las, recibir, por, los
2: flint, builders, flint builders, project, flintbuilders
3: www wsu, wsu iran, www wsu iran, youtube com sosyalismkargari, com sosyalismkargari, sosyalismkargari, http www wsu, http www youtube, youtu, wsu
4: mass mailing media, email unsubscribe subscribe, mailing, unsubscribe subscribe, media email unsubscribe, media email, mass mailing
5: upgrade email accessing, master access mailbox, mailbox expire recommend, mailbox expire, hrs thanks, expire recommend upgrade, email account hrs, email accessing email, email accessing, dear master access
6: error safely unsubscribe, sent error safely, believe sent error, safely unsubscribe, error safely, believe sent, sent error, safely, privacy policy, unsubscribe view privacy
7: address [symbol] [symbol] copyright, [symbol] [symbol] [symbol] [symbol] [symbol] copyright, [symbol] [symbol]
[symbol] [symbol] [symbol] [symbol] [symbol] [symbol] [symbol] master, [symbol] [symbol] [symbol] [symbol] [symbol] [symbol]
9: account hold, using mailbox validate, using mailbox, thank account team, thank account, ownership validation to continue, ownership validation to, ownership email address, ownership email, validate ownership email
10: [symbol] cc af cc
11: di, il, che, tiro, reggio, tsn, segno, emilia, tiro segno, reggio emilia
12: com sent, pm, com subject, subject, sender, confidential, attachments, intended, contain, intended recipient
13: receive, like, forward, help, want, new, learn, receive emails, people, future
14: attached, fax, office, manager, questions, send, payment, document, mail, thanks best
15: best, best regards, let, need, company, good, let know, years, building, provide
16: information, know, regards, time, received, kindly, use, details, recipient, confirm
17: ec, bf, ea, haz clic en, ef, dc, fd, hcm, https www, ee
18: gmail, gmail com, www, com, se, image, com cc, cc, le, data
19: account, continue, team, continue using, using, message sent, secure, emails, verify account, meta platforms
20: email address, address, email

A topic model may be used to discover the topic(s) in each cluster. Topic models may be trained machine learning models which focus on how often words occur and co-occur within each data item. The models may group commonly co-occurring words into sets of topics. For example, if the words “confidential”, “attachments”, and “intended recipient” appear/occur together frequently, then these words may be grouped together to form a topic. There are many types of topic model. For example, a correlation explanation (CorEx) algorithm may be used to discover topics that are informative about the data items in each cluster. The CorEx algorithm (as described in, for example, Discovering Structure in High-Dimensional Data Through Correlation Explanation—Greg Ver Steeg and Aram Galstyan, NIPS 2014, http://arxiv.org/abs/1406.1222; and Maximally Informative Hierarchical Representations of High-Dimensional Data—Greg Ver Steeg and Aram Galstyan, AISTATS 2015, http://arxiv.org/abs/1410.7404) may be applied to each cluster, one-by-one. It will be understood that other techniques or algorithms or topic models may be used to discover topics that are descriptive of the uncategorised data items in each cluster.

With respect to the twenty groups of common keywords/phrases, these can be analysed by CorEx or an alternative technique (such as an LLM) to obtain topics, such as:
General Spanish Language Communication: This topic includes common Spanish words like “que”, “en”, “la”, “para”, “el”, suggesting general or diverse content in Spanish-language emails.
Construction and Project Management: The presence of names like “Jason”, “Flint”, “Oliver” and terms like “builders”, “project” suggests emails related to construction projects or business correspondence within the building industry.
Online Media and International Content: Words like “www”, “youtube”, “wsu iran”, indicate content related to online media, possibly involving international or academic subjects, given the inclusion of a university acronym (WSU).
Email Marketing and Subscription Management: This topic, with phrases like “mass mailing media”, “email unsubscribe subscribe”, is clearly about email marketing, newsletters, and subscription management.
Email Accessibility and Security Notices: Includes terms related to email access and security, like “upgrade email”, “mailbox expire”, “accessing email”, indicating system-generated messages about email account maintenance or security.
Chinese Language Technical Support: Contains Chinese phrases, suggesting technical support or account-related notifications in Chinese, possibly involving link expiration and website access instructions.
Chinese Language Email Notifications: This topic also includes Chinese content, focusing on email validation and password expiration notices, indicating administrative or security-related email communications.
Email Account Validation and Security: Words like “account hold”, “mailbox validate”, “ownership email” suggest emails related to account validation, ownership confirmation, and security procedures.
Persian Language Communications: The presence of Persian characters and words suggests this topic is related to emails in Persian, possibly covering a range of subjects given the general nature of the words.
Italian Language and Local Content: This topic, with Italian words like “di”, “il”, “reggio emilia”, “tiro segno”, implies emails related to local Italian events or organizations, possibly sports or cultural activities.
Professional and Confidential Communications: Includes terms like “confidential”, “attachments”, “intended recipient”, indicating emails that are business-oriented and contain sensitive or confidential information.
General Communication and Networking: Words like “receive”, “like”, “forward”, “new”, suggest general correspondence, networking, or information sharing.
Business Operations and Transactions: The presence of words like “attached”, “fax”, “payment”, “document” indicates emails related to business operations, document sharing, and financial transactions.
Professional Courtesies and Business Relations: Terms like “best regards”, “company”, “years”, “building” suggest professional communications, possibly in a corporate or business setting.
Information Requests and Confirmations: This topic, with words like “information”, “confirm”, “details”, “recipient”, is about information exchange, confirmation requests, or follow-up on previous communications.
Encoded or Technical Content: Contains a mix of alphanumeric codes and technical terms, suggesting emails with technical content, possibly related to IT or digital services.
Email and Data Management: The presence of “gmail”, “www”, “image”, “data” indicates emails related to online communications, data management, and possibly image or file sharing.
Account Management and Security: Words like “account”, “continue using”, “verify account”, imply emails about account management, security notifications, and platform updates.
Email Address and Identity Confirmation: The final topic, with “email address”, “address”, “email”, focuses on email identity, possibly involving address confirmation or updates.

In this example, the method may further comprise specifying a maximum number of topics to be generated for the plurality of uncategorised data items. For example, when using the CorEx algorithm, the number of topics (k) need to be input into the algorithm, and CorEx will then analyse the documents and categorize them into k topics.

In this example, the step of generating, using a large language model, at least one classification label may comprise: inputting the at least one topic for each cluster into the large language model, LLM; and obtaining for each topic, from the LLM, at least one classification label and a description of the topic. That is, an LLM may be used to generate a more detailed description of each topic. To do so, anchor words from each topic may be input into the LLM, and the LLM may output a coherent and comprehensive description of the topic based on the anchor words. The result will be a set of k topics, each with a detailed description provided by the LLM. Anchor words are a type of guidance given to the LLM to influence the topics it generates. Anchor words are essentially seed words that are strongly associated with a specific topic. By specifying anchor words, it is possible to guide the LLM to form topics around certain themes. This is particularly useful when prior knowledge about the data items exists and it is desirable to ensure that certain topics are captured by the LLM.

In another example, the labels may be generated by taking a sample of data items from a cluster, and sending the sample to an LLM (commercial or open source) for analysis. Prompt engineering may be used to determine the best prompt(s) to for the LLM in order to extract the best fitting labels for the sample of data items.

In other words, in this second example, the step of generating, using a large language model, at least one classification label may comprise: selecting a sample of uncategorised data items from the cluster; inputting the sample of uncategorised data items into the large language model, LLM together with at least one prompt to instruct the LLM to output at least one classification label; and obtaining, from the LLM, at least one classification label for the input sample of uncategorised data items. In this example, compared to the example above, the step of generating a topic is bypassed. Instead, the LLM is used to directly generate a classification label or labels for each input sample of uncategorised data items. In other words, a sample of documents is input into an LLM (commercial or open source), and prompt engineering is used to extract the best fitting category or label for those input sample documents.

In this example, the LLM may be instructed/prompted to generate a high-level category (to prevent more than [C] categories—configurable, e.g. 100). This prompt may contain a set of strict guidelines to make sure that the model does not violate any Responsible AI rule such as discrimination or racism. The model may be able to return only one of the predefined categories, this will be validated upon the return of the result before the system uses this categorization. In addition, the system may use a low temperature parameter to make sure that the model is more deterministic with low creativity.

In other words, in this example, the method may further comprise: inputting, into the LLM, a maximum number of classification labels to be generated by the LLM. Thus, the LLM may be promoted to generate a high-level category/label or a specific number of labels, to prevent too many labels being generated. For example, one unique label per data items would not be a useful way to categorise all of the uncategorised data items because no actions can then be taken or policies applied to a whole group of data items with the same labels. The maximum number of classification labels may be configurable based on the environment or user-specific requirements.

In this example, the method may further comprise: inputting, into the LLM, at least one further prompt to ensure the at least one classification label complies with predefined responsible AI guidelines. This prompt may contain a set of strict guidelines to make sure that the LLM does not violate any Responsible AI rule such as ensuring the outputs of the LLM are not discriminatory or racist. The LLM may be able to return only one of the predefined categories, which will be validated upon the return of the result before the categories can be applied to the uncategorised data items as labels.

The system 100 applies, to each uncategorised data item in each cluster, the at least one classification label generated for the cluster, thereby generating a labelled data item.

Returning to FIG. 1, this largely shows the process performed to classify new uncategorised data items after a vector database 116 has been generated and some initial data items have already been clustered and classified. Once an initial set of data items have been categorised, it may be faster to categorise new uncategorised data items, because their embedding vectors can be compared to the embedding vectors in the vector database 116 and used to quickly determine how to cluster and categorise the new uncategorised data items. a vector once the embedding vectors have been generated for the uncategorised data items.

Thus, when a new uncategorised data item is received and has been processed by DCE 108 and DEP 110, at least one embedding vector has been generated for the new uncategorised data item. The collector 102 compares the generated at least one embedding vector to the database 116 of stored embedding vectors, as shown at step 3 of FIG. 1. Thus, at step 3, matching between the embedding vector of the new uncategorised data item and the embedding vectors of the learning set/vector database 116 is performed. The collector 102 may select, responsive to the comparing, at least one stored embedding vector (from database 116) that is most similar to the generated at least one embedding vector for the new uncategorised data item, and may then apply to the new uncategorised data item, at least one classification label corresponding to the selected at least one stored embedding vector, thereby generating a new labelled data item.

At step 3, comparing the generated at least one embedding vector to the database of stored embedding vectors may comprise: calculating a cosine similarity between the generated at least one embedding vector and each stored embedding vector. Cosine similarity is a measure of the similarity between two vectors, and is calculated by determining the cosine of the angle θ between the two vectors. When θ is close to 0°, cosine θ is close to 1, which means the vectors are similar; when θ is close to 90°, cosine θ is close to 0, which means the vectors are orthogonal; and when θ is close to 180°, cosine θ is close to −1 which means the vectors are opposite.

Selecting at least one stored embedding vector that is most similar to the generated at least one embedding vector may comprise: selecting at least one stored embedding vector that is within a predefined threshold distance in embedding space from the generated at least one embedding vector. For example, the cosine similarity may be used to determine which stored embedding vector is most similar to each embedding vector. Additionally or alternatively, each stored embedding vector within a predefined threshold distance (e.g. having a cosine θ value in a certain range), may be considered similar to the generated embedding vector.

In some cases, applying, to the new uncategorised data item, the classification label corresponding to the selected at least one stored embedding vector may comprise: applying a single classification label to the uncategorised data item. That is, each uncategorised data item is labelled within a single classification label that is most representative of the data item or information contained within the data item.

Alternatively, applying, to the uncategorised data item, the classification label corresponding to the selected at least one stored embedding vector may comprise: applying multiple classification labels to the uncategorised data item when multiple stored embedding vectors are selected. In such cases, multiple classification labels may be necessary to fully represent the data item or information contained within the data item. This may occur in cases where the extracted text has been divided into segments and each segment results in a different classification label being applied. Alternatively, this may occur when the data item corresponds to multiple labels. For example, the data item may be an email, and “email” may be a label, but the content of the email may be confidential, and “confidential” may be a label. In this case, it is appropriate to apply two labels to the data item.

Optionally, at step 4, data items classified as sensitive may be sent to the cloud 104 and stored in a vector index 122 (irreversible vector). Thus, the remote/cloud server 104 may comprise an index 122 storing information about data items that are classified as sensitive by owners of the data items. The owners/users may indicate (e.g. via a data management policy) that sensitive data items cannot be accessed, viewed or edited by anyone, or can only be accessed, viewed or edited by someone who is explicitly authorised to do so. This may be useful if anyone or a system administrator is able to query how a data item has been classified, but some data items are sensitive (e.g. they relate to business information or personnel files), and so should not be freely accessible/readable.

At step 3, if there is no match, the embedding vector is stored in the clustering VectorDB 114, as shown by step 5 in FIG. 1. Thus, in cases when none of the stored embedding vectors in the learning set vector database 116 are similar to the generated at least one embedding vector for the new uncategorised data item, the collector 102 may store, in a second database 114, the new uncategorised data item. For the first [W] uncategorised data items within an environment (where W is configurable, e.g. 100,000 data items), this step is performed by the collector 102 instead of the matching step, because at this stage, there is no learning set 116. Preferably, [W]>=1,000 for initial clustering accuracy. Thus, for the first W uncategorised data items, the embedding vectors are generated, and then the data items and their embedding vectors are stored in the clustering vector database 114, until there are enough data items in the database 114 to perform the initial clustering and labelling process (described above).

Similarly, the collector 102 may only perform the clustering of new uncategorised data items when the second database 114 contains a predefined threshold number of new uncategorised data items. That is, the second database 114 is analysed when a predefined threshold number of uncategorised data items exist, for the sake of efficiency. Specifically, when the second database 114 contains a predefined threshold number of new uncategorised data items, the collector 102 may cluster, using the generated at least one embedding vector for each new uncategorised data item, the new uncategorised data items into a plurality of clusters, where each cluster contains a subset of the new uncategorised data items that are more similar to each other than to the new uncategorised data items in other clusters.

The collector 102 may comprise an Autonomous Clustering and Categorizer (ACC) 118. The ACC 118 may check, periodically, the number of uncategorized data items in the Clustering VectorDB 114 (as shown by step 6 in FIG. 1). Once the number of uncategorized data items in the Clustering VectorDB 114 reaches a predefined threshold (e.g. first time>=[W] files, afterwards>=[T] files), the ACC 118 initiates the autonomous clustering process, as described above.

If any new clusters and labels are generated for the new uncategorised data items in the clustering vector database 114, their corresponding embedding vectors (or a sample of them), may be added to the Learning set VectorDB 116, for future use and reference. Once an uncategorised data item in the database 114 has been categorised, it is removed from the Clustering VectorDB 114. Any uncategorized data items remaining in the Clustering VectorDB 114 will remain there until a suitable cluster is found for them.

The system 100 may comprise a remote server 104 configured for receiving, from the plurality of collectors 102, 120, the generated at least one embedding vector for each uncategorised data item; generating a combined set 128 of embedding vectors representative of data items in the environment; and transmitting, to the plurality of collectors 102, 120, the combined set 128 of embedding vectors, for use when categorising new uncategorised data items. That is, because each processor/collector performs the categorisation with respect to one of the plurality of data sources, it may only see limited types of data items, and may not know how to categorise other types of data item that are less common or uncommon in that particular data source. Sharing the set 128 of embedding vectors that are generated by all the processors with all the processors means that each processor has more information to use when recategorisation needs to be performed or categorisation of new uncategorised data items needs to be performed.

Thus, as shown at step 8 in FIG. 1, the learning set vector database 116 of each collector 102 is uploaded from the collector 102 to the cloud/remote server 104. To minimize network traffic and reduce the storage footprint of VectorDB 128 in the cloud 104, only normalized average vectors may be uploaded, rather than the vectors for each individual chunk/segment. Uploading embedding vectors serves two primary purposes: Firstly, the vectors are integral to the explainability process, enabling users to identify the most pertinent document from the learning set. Should finer detail be required, users can then request the particular chunk, which will be fetched from the collector. Secondly, the vectors are distributed among all the other collectors for synchronization.

At step 9, the remote server 104 distributes the updated learning set 128 to all collectors (normalized vectors only). These may then replace the learning sets 116 of each collector.

The categorisation process performed by each collector 102 may further comprise: outputting information explaining how the at least one classification label of the new labelled data item is determined. The remote server 104 may, at step 10, perform classification management.

For example, as noted above, only normalized vectors are transferred to the cloud 104. Should a user 130 require a more detailed understanding of why the system 100 identified a particular document from the learning set 116 as the most suitable match, the system may be able to retrieve the top-most similar chunks from the collector 102, enabling the user 130 to examine it thoroughly and determine whether to concur with the classification or remove the reference document from the learning set. (Thus, the remote/cloud server 104 may comprise a user interface to enable user 130 to interrogate the label/categorisation applied to any data item). For the user to be able to see the specific document or chunk that was used to categorise a new data item, an authorisation process is required, that ensures the owner of the specific document/data item provides authorisation for the document/data item to be viewed and/or that ensures the user 130 is allowed/authorised to view the document/data item. Thus, ‘the system 100 will fetch and present the document/chunk only to an authorized user. Otherwise, it will refuse to disclose a potentially sensitive document or part of it (which is known due to step 4 of the process, and information stored in the sensitive documents vector index 122).

If a user disagrees with a given categorization, they may take one of the following actions:
Remove the reference data item (and/or the corresponding embedding vector(s) from the database 116, 128;
   OPTIONAL—the system will present an impact analysis detailing all other data items categorized using this reference. That is, if the reference data item has caused miscategorised of a given data item, the same reference data item may have caused other data items to be miscategorised, so the system may determine whether these other data items also need to be recategorized without using this reference data item. If so, all impacted data items may be recategorized by performing the matching step again once the reference data item has been removed from database 116;
Reassign the reference document to a more appropriate category;
Expand the learning set by adding additional documents by splitting to sub-categories. For each category, the system 100 may pre-compute sub-categories. For example, this can be done by running k-means with different values of k, or using hierarchal clustering, which outputs a hierarchy with different “resolutions”. The system may request the user to indicate if they want a more general or more specific category to be used. The user may also be able to ask the system to break down a category into two or more sub-categories (in such a case this involves running k-means with k=2 on the category).

FIG. 3 is a flowchart of example steps for autonomously classifying uncategorised data items within an environment. The method may be performed once, in order to generate the initial learning dataset, and only once a threshold number of uncategorised data items exist. The method comprises: obtaining, from at least one data source within the environment, a plurality of uncategorised data items (step S100); generating, using a machine learning, ML, model, at least one embedding vector for each uncategorised data item, where the at least one embedding vector represents content of each uncategorised data item (step S102); clustering, using the at least one embedding vector generated for each uncategorised data item, the plurality of uncategorised data items into a plurality of clusters, where each cluster contains a subset of the plurality of uncategorised data items that are more similar to each other than to the uncategorised data items in other clusters (step S104); generating, using a large language model, LLM, at least one classification label specific to content of the subset of the plurality of uncategorised data items in the cluster (step S106); and applying, to each uncategorised data item in each cluster, the at least one classification label generated for the cluster, thereby generating a labelled data item (step S108).

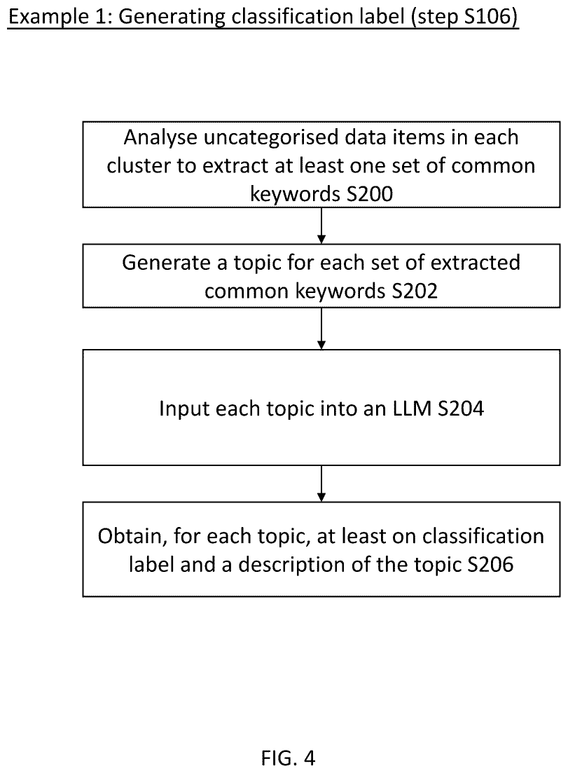

FIG. 4 is a flowchart showing steps of one example technique for generating classification labels. That is, FIG. 4 shows one example way of implementing step S106 of FIG. 3. The method comprises: analysing the uncategorised data items in each cluster to extract at least one set of common keywords (step S200). The method comprises generating a topic for each set of extracted common keywords (step S202). A topic model may be used to discover the topic(s) in each cluster. Topic models may be trained machine learning models which focus on how often words occur and co-occur within each data item. The models may group commonly co-occurring words into sets of topics. For example, if the words “confidential”, “attachments”, and “intended recipient” appear/occur together frequently, then these words may be grouped together to form a topic.

The method may further comprise specifying, before step S200, a maximum number of topics to be generated for the plurality of uncategorised data items. For example, when using the CorEx algorithm, the number of topics (k) need to be input into the algorithm, and CorEx will then analyse the documents and categorize them into k topics. Thus, at step S200, the method may comprise extracting no more than the same number of sets of common keywords, to ensure no more than the specified number of topics is generated at step S202.

The method may comprise: inputting the at least one topic for each cluster into the large language model, LLM (step S204); and obtaining for each topic, from the LLM, at least one classification label and a description of the topic (step S206). That is, an LLM may be used to generate a more detailed description of each topic. To do so, anchor words from each topic may be input into the LLM, and the LLM may output a coherent and comprehensive description of the topic based on the anchor words. The result will be a set of k topics, each with a detailed description provided by the LLM. Anchor words are a type of guidance given to the LLM to influence the topics it generates. Anchor words are essentially seed words that are strongly associated with a specific topic. By specifying anchor words, it is possible to guide the LLM to form topics around certain themes. This is particularly useful when prior knowledge about the data items exists and it is desirable to ensure that certain topics are captured by the LLM.

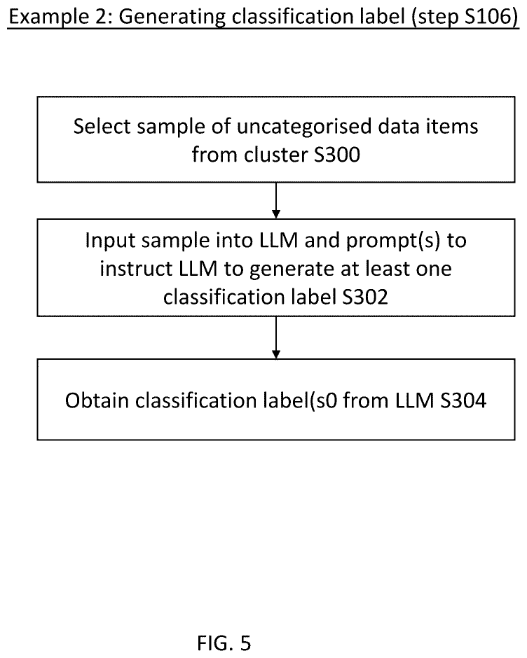

FIG. 5 is a flowchart showing steps of one example technique for generating classification labels. That is, FIG. 5 shows another example way of implementing step S106 of FIG. 3. The method comprises: selecting a sample of uncategorised data items from the cluster (step S300); inputting the sample of uncategorised data items into the large language model, LLM together with at least one prompt to instruct the LLM to output at least one classification label (step S302); and obtaining, from the LLM, at least one classification label for the input sample of uncategorised data items (step S304). In this example, compared to the example above, the step of generating a topic is bypassed. Instead, the LLM is used to directly generate a classification label or labels for each input sample of uncategorised data items. In other words, a sample of documents is input into an LLM (commercial or open source), and prompt engineering is used to extract the best fitting category or label for those input sample documents.

In this example, the method may further comprise: inputting at step S302, into the LLM, a maximum number of classification labels to be generated by the LLM. Thus, the LLM may be promoted to generate a high-level category/label or a specific number of labels, to prevent too many labels being generated. For example, one unique label per data items would not be a useful way to categorise all of the uncategorised data items because no actions can then be taken or policies applied to a whole group of data items with the same labels. The maximum number of classification labels may be configurable based on the environment or user-specific requirements.

In this example, the method may further comprise: inputting at step S302, into the LLM, at least one further prompt to ensure the at least one classification label complies with predefined responsible AI guidelines. This prompt may contain a set of strict guidelines to make sure that the LLM does not violate any Responsible AI rule such as ensuring the outputs of the LLM are not discriminatory or racist. The LLM may be able to return only one of the predefined categories, which will be validated upon the return of the result before the categories can be applied to the uncategorised data items as labels.

Preferably, a low temperature parameter may be used to make sure that the LLM is more deterministic, with low creativity. That is, it is desirable to prevent the LLM from being too creative, and to instead be more predictable, because it is desirable to obtain the same topics and/or classification labels and/or descriptions each time the same data items are processed by the LLM. Certain LLMs have a temperature parameter, typically ranging from 0 to 2. This parameter controls how deterministic the outputs of the LLM are. A lower temperature results in more predictable responses, while a higher temperature can produce more varied answers.

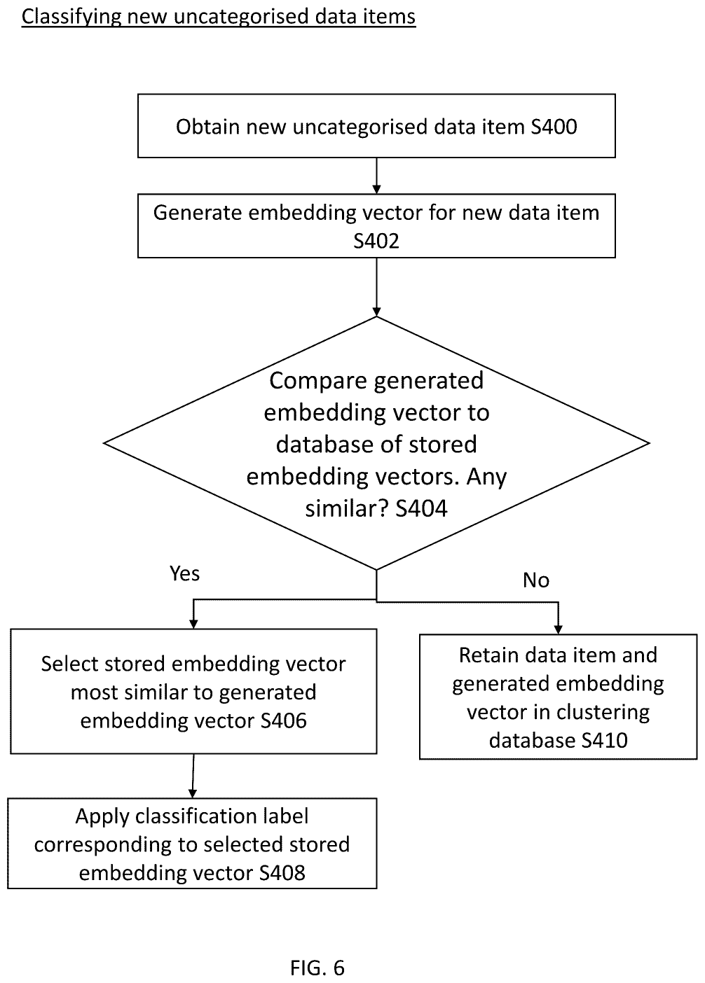

FIG. 6 is a flowchart of example steps to categorise new uncategorised data items after the initial learning dataset has been created (FIG. 3). The method comprises: obtaining a new uncategorised data item (step S400); generating at least one embedding vector for the new uncategorised data item (step S402) using the process described above; and comparing the generated at least one embedding vector to the database of stored embedding vectors (step S404).

The step (S404) of comparing the generated at least one embedding vector to the database of stored embedding vectors may comprise: calculating a cosine similarity between the generated at least one embedding vector and each stored embedding vector. Cosine similarity is a measure of the similarity between two vectors, and is calculated by determining the cosine of the angle θ between the two vectors. When θ is close to 0°, cosine θ is close to 1, which means the vectors are similar; when θ is close to 90°, cosine θ is close to 0, which means the vectors are orthogonal; and when θ is close to 180°, cosine θ is close to −1 which means the vectors are opposite.

The method comprises selecting, responsive to the comparing, at least one stored embedding vector that is most similar to the generated at least one embedding vector for the new uncategorised data item (step S406); and applying to the new uncategorised data item, at least one classification label corresponding to the selected at least one stored embedding vector, thereby generating a new labelled data item (step S408). Selecting, at step S406, at least one stored embedding vector that is most similar to the generated at least one embedding vector may comprise: selecting at least one stored embedding vector that is within a predefined threshold distance in embedding space from the generated at least one embedding vector. For example, the cosine similarity may be used to determine which stored embedding vector is most similar to each embedding vector. Additionally or alternatively, each stored embedding vector within a predefined threshold distance (e.g. having a cosine θ value in a certain range), may be considered similar to the generated embedding vector.

At step S404, if none of the stored embedding vectors are similar to the generated at least one embedding vector for the new uncategorised data item, the method may comprise: storing, in a second database 114, the new uncategorised data item (step S410).

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1. A computer-implemented method for autonomously classifying uncategorised data items within an environment, the method comprising:
obtaining, from at least one data source within the environment, a plurality of uncategorised data items;
generating, using a machine learning, ML, model, at least one embedding vector for each uncategorised data item, where the at least one embedding vector represents content of each uncategorised data item;
clustering, using the at least one embedding vector generated for each uncategorised data item, the plurality of uncategorised data items into a plurality of clusters, where each cluster contains a subset of the plurality of uncategorised data items that are more similar to each other than to the uncategorised data items in other clusters;
generating, using a large language model, LLM, at least one classification label for each cluster, wherein the at least one classification label is specific to content of the subset of the plurality of uncategorised data items in the cluster; and
applying, to each uncategorised data item in each cluster, the at least one classification label generated for the cluster, thereby generating a labelled data item.

2. The method of claim 1 wherein obtaining a plurality of uncategorised data items comprises obtaining any one or more of: an email, a document, a file, a text file, a folder, an image, a video, an audio file, a diagram, a geographical map, a medical image, a medical data file, and a portable document format file.

3. The method of claim 1 wherein clustering the plurality of uncategorised data items comprises using any one of: a data clustering algorithm, a k-means clustering algorithm, and a density-based spatial clustering algorithm.

4. The method of claim 1 wherein, when a single embedding vector is generated for each uncategorised data item, clustering the plurality of uncategorised data items comprises clustering each embedding vector in embedding space, and thereby clustering the plurality of uncategorised data items into a plurality of clusters.

5. The method of claim 1 further comprising:
prior to generating at least one embedding vector, dividing the uncategorised data item into two or more segments;
wherein generating the at least one embedding vector comprises generating an embedding vector for each of the two or more segments.

6. The method of claim 5 further comprising:
calculating an average embedding vector for each uncategorised data item by averaging the embedding vector generated for each segment of the data item;
wherein clustering the plurality of uncategorised data items comprises clustering the average embedding vectors in embedding space, and thereby clustering the plurality of uncategorised data items into a plurality of clusters.

7. The method of claim 1 wherein generating, using a large language model, at least one classification label comprises:
analysing the uncategorised data items in each cluster to determine at least topic representative of content of the subset of the plurality of uncategorised data items in the cluster.

8. The method of claim 7 further comprising specifying a maximum number of topics to be generated for the plurality of uncategorised data items.

9. The method of claim 7 wherein generating, using a large language model, at least one classification label comprises:
inputting the at least one topic for each cluster into the large language model, LLM; and
obtaining for each topic, from the LLM, at least one classification label and a description of the topic.

10. The method of claim 1 wherein generating, using a large language model, at least one classification label comprises:
selecting a sample of uncategorised data items from the cluster;
inputting the sample of uncategorised data items into the large language model, LLM together with at least one prompt to instruct the LLM to output at least one classification label; and
obtaining, from the LLM, at least one classification label for the input sample of uncategorised data items.

11. The method of claim 10 further comprising:
inputting, into the LLM, a maximum number of classification labels to be generated by the LLM.

12. The method of claim 10 further comprising:
inputting, into the LLM, at least one further prompt to ensure the at least one classification label complies with predefined responsible AI guidelines.

13. The method of claim 1 further comprising:
storing, in a database, the generated embedding vectors and associated classification label.

14. The method of claim 13 further comprising:
obtaining a new uncategorised data item;
generating at least one embedding vector for the new uncategorised data item;
comparing the generated at least one embedding vector to the database of stored embedding vectors;
selecting, responsive to the comparing, at least one stored embedding vector that is most similar to the generated at least one embedding vector for the new uncategorised data item; and
applying to the new uncategorised data item, at least one classification label corresponding to the selected at least one stored embedding vector, thereby generating a new labelled data item.

15. The method of claim 14 further comprising:
outputting information explaining how the at least one classification label of the new labelled data item is determined.

16. The method of claim 14 wherein when none of the stored embedding vectors are similar to the generated at least one embedding vector for the new uncategorised data item, the method comprises:
storing, in a second database, the new uncategorised data item.

17. The method of claim 16 wherein when the second database contains a predefined threshold number of new uncategorised data items, the method further comprises clustering, using the generated at least one embedding vector for each new uncategorised data item, the new uncategorised data items into a plurality of clusters, where each cluster contains a subset of the new uncategorised data items that are more similar to each other than to the new uncategorised data items in other clusters.

18. A system for autonomously classifying uncategorised data items within an environment, the system comprising:
a plurality of data sources within the environment; and
a plurality of processors, each processor being coupled to one of the plurality of data sources and configured for:
obtaining, from the data source, a plurality of uncategorised data items;
generating, using a machine learning, ML, model, at least one embedding vector for each uncategorised data item, where the at least one embedding vector represents content of each uncategorised data item;
clustering, using the at least one embedding vector generated for each uncategorised data item, the plurality of uncategorised data items into a plurality of clusters, where each cluster contains a subset of the plurality of uncategorised data items that are more similar to each other than to the uncategorised data items in other clusters;
generating, using a large language model, LLM, at least one classification label for each cluster, wherein the at least one classification label is specific to content of the subset of the plurality of uncategorised data items in the cluster; and
applying, to each uncategorised data item in each cluster, the at least one classification label generated for the cluster, thereby generating a labelled data item.

19. The system of claim 18 further comprising a remote server configured for:
receiving, from the plurality of processors, the generated at least one embedding vector for each uncategorised data item;
generating a combined set of embedding vectors representative of data items in the environment; and
transmitting, to the plurality of processors, the combined set of embedding vectors, for use when categorising new uncategorised data items.
